(19) United States
(12) Patent Application Publication
(10) Pub. No.: US 2021/0390792 A1
(43) Pub. Date: Dec. 16, 2021

(54) METHOD AND DEVICE FOR CUSTOMIZING FACIAL EXPRESSIONS OF USER

(71) Applicant: Tsinghua University, Beijing (CN)

(72) Inventors: Feng XU, Beijing (CN); Zhibo WANG, Beijing (CN); Chengzeng FENG, Beijing (CN); Jingwang LING, Beijing (CN); Dong YANG, Beijing (CN)

(21) Appl. No.: 17/462,113

(22) Filed: Aug. 31, 2021

Related U.S. Application Data
(63) Continuation of application No. PCT/CN2020/108965, filed on Aug. 13, 2020.

(30) Foreign Application Priority Data
Sep. 6, 2019 (CN) 201910840594.X

(51) Int. Cl. G06T 19/20; G06T 13/40; G06T 7/55; G06K 9/00

(52) U.S. Cl. CPC G06T 19/20; G06T 13/40; G06T 7/55; G06T 2219/2021; G06T 2200/04; G06T 2200/08; G06T 2207/10016; G06K 9/00255

(57) ABSTRACT

A method for customizing facial expressions of a user includes: obtaining a RGB-D image sequence, performing non-rigid registration on a three-dimensional (3D) face template model with a depth map and face feature points corresponding to the RGB-D image sequence, inputting each vertex in the non-rigid registration result into the depth map to generate a set of deformation data, and deforming the 3D face template model based on the set of deformation data; reconstructing face details in the RGB-D image sequence, and generating a 3D neutral face model based on the deformed 3D face template model and the reconstructed 3D face template model; processing the 3D neutral face model and a face hybrid template to generate a face hybrid model; tracking the face in the RGB-D image sequence to generate a face tracking result; and updating the face hybrid model based on the face tracking result and customizing the facial expressions.

### CROSS REFERENCE TO RELATED APPLICATIONS

This application is a continuation application of International Application No. PCT/CN2020/108965 filed on Aug. 13, 2020 which claims priority to Chinese Patent Application No. 201910840594.X filed by Tsinghua University on Sep. 6, 2019, with the title of “METHOD AND DEVICE FOR AUTOMATICALLY GENERATING CUSTOMIZED FACE HYBRID EMOTICON MODEL”, the entire contents of which are incorporated herein by reference.

### TECHNICAL FIELD

The disclosure relates to the technical field of three-dimensional (3D) face animation reconstruction, and in particular relates to a method and an apparatus for customizing facial expressions of a user.

### BACKGROUND

The high-precision hybrid model for customizing facial expressions includes a face shape when a person makes some specific expressions. Different shapes constitute different expression bases in the hybrid model. In the fields of movies, animation, games, etc., a set of expression coefficients can be used to quickly generate a three-dimensional (3D) face animation.

### SUMMARY

According to a first aspect of the disclosure, a method for customizing facial expressions of a user, including: obtaining a RGB-D image sequence including a neutral expression of the user, performing non-rigid registration on a three-dimensional (3D) face template model with a depth map and face feature points corresponding to each image of the RGB-D image sequence, inputting each vertex in the non-rigid registration result into the depth map corresponding to each image to generate a set of deformation data, and deforming the 3D face template model based on the set of deformation data; reconstructing face details in the non-rigidly registered 3D face template model by a Shape from Shading technology in the last image of the RGB-D image sequence, and generating a 3D neutral face model based on the deformed 3D face template model and the reconstructed 3D face template model; processing the 3D neutral face model and face hybrid template by a Deformation Transfer technology to generate a face hybrid model; and tracking the face in the RGB-D image sequence by deforming the 3D neutral face model sequentially through the customized face hybrid model, a Warping Field technology and the Shape from Shading technology, to generate a face tracking result; and updating the face hybrid model based on the face tracking result and customizing the facial expressions with the updated face hybrid model. According to a second aspect of the disclosure, an apparatus for customizing facial expressions of a user includes a processor and a memory having instructions stored thereon and executable by the processor. When the instructions are executed by the processor, the processor is configured to obtain a RGB-D image sequence including a neutral expression of the user, perform non-rigid registration on a three-dimensional (3D) face template model with a depth map and face feature points corresponding to each image of the RGB-D image sequence, input each vertex in the non-rigid registration result into the depth map corresponding to each image to generate a set of deformation data, and deform the 3D face template model based on the set of deformation data; reconstruct face details in the non-rigidly registered 3D face model by a Shape from Shading technology in the last image of the RGB-D image sequence, and generate a 3D neutral face model based on the deformed 3D face template model and the reconstructed 3D face template model; process the 3D neutral face model and a face hybrid template by a Deformation Transfer technology to generate a face hybrid model; track the face in the RGB-D image sequence by deforming the 3D neutral face model sequentially through the face hybrid model, a Warping Field technology and the Shape from Shading technology, to generate a face tracking result; update the face hybrid model based on the face tracking result and customize the facial expressions with the updated face hybrid model.

According to a third aspect of the disclosure, a non-transitory computer readable storage medium has instructions stored thereon. When the instructions are executed by a processor, a method for customizing facial expressions of a user is performed according to the first aspect of the disclosure.

The additional aspects and advantages of the disclosure will be partly given in the following description, and some will become obvious from the following description, or be understood through the practice of the disclosure.

### BRIEF DESCRIPTION OF THE DRAWINGS

The above and/or additional aspects and advantages of the disclosure will become obvious and easy to understand from the following description of the embodiments in conjunction with the accompanying drawings, in which:

FIG. 1 is a flowchart of a method for customizing facial expressions according to an embodiment of the disclosure.

FIG. 2 is a structural schematic diagram of an apparatus for customizing facial expressions according to an embodiment of the disclosure.

FIG. 3 is a block diagram illustrating an electronic device 50 according to an example embodiment of the disclosure.

### DETAILED DESCRIPTION

Embodiments of the disclosure are described in detail below. Examples of the embodiments are shown in the accompanying drawings, throughout which the same or similar reference numbers indicate the same or similar elements or the elements with the same or similar functions. The embodiments described below with reference to the drawings are exemplary, and are intended to explain the disclosure, but should not be understood as a limitation to the disclosure.

The following describes a method and an apparatus for customizing facial expressions according to the embodiments of the disclosure with reference to the accompanying drawings.

The face hybrid model for customizing facial expressions is a 3D facial expressions model that is often used in movies and animations to make face animations, which may also be used for tracking a face. The commonly used methods of making a high-precision face hybrid model for facial expressions often require expensive devices. Simple automation methods are difficult to meet accuracy requirements and unable to restore face details such as moles and wrinkles on the face.

To solve the above problem in the related art, the disclosure provides a method and an apparatus for customizing facial expressions and a storage medium, which may perform high-precision tracking on the face in the color and depth image sequence and generate a face hybrid model for customizing facial expressions directly with the high-precision tracking results. That is, it is achieved that the face hybrid model for customizing facial expressions may be automatically generated with low cost, and realistic facial expressions may be generated in real time by the updated face hybrid model with high precision.

Firstly, the method for customizing facial expressions according to an embodiment of the disclosure will be described with reference to the accompanying drawings.

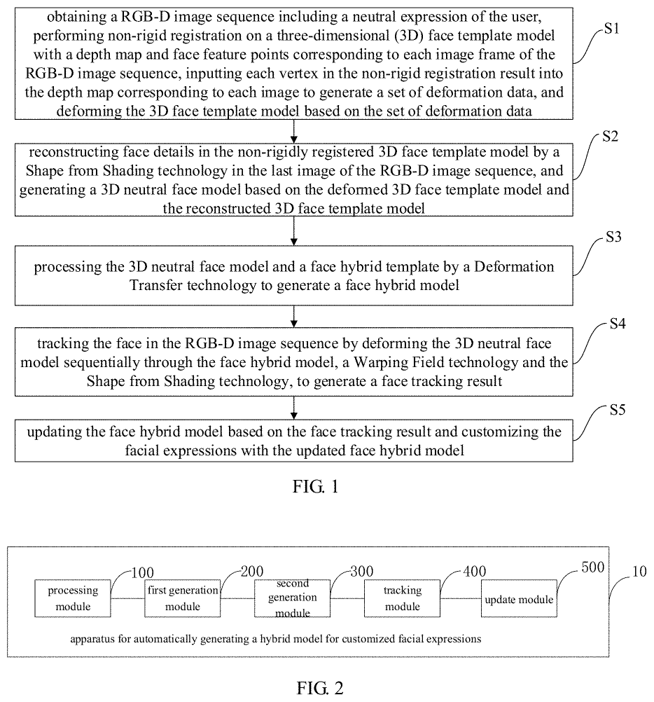

FIG. 1 is a flowchart of a method for customizing facial expressions according to an embodiment of the disclosure.

As illustrated in FIG. 1, the method for customizing facial expressions includes the following steps.

At block S1, an RGB-D image sequence including a neutral expression of a user is obtained, non-rigid registration is performed on a three-dimensional (3D) face template model with a depth map and face feature points corresponding to each image of the RGB-D image sequence, each vertex in the non-rigid registration result is input into the depth map corresponding to each image to generate a set of deformation data, and the 3D face template model is deformed based on the set of deformation data.

Further, each image frame of a neutral expression of the user is collected to form the RGB-D image sequence by allowing the user to rotate his/her head in up, down, left, and right directions while maintaining the neutral expression.

The resolution of the RGB-D image sequence used in the embodiment of the disclosure is 640×480.

Further, in an embodiment of the disclosure, inputting each vertex in the non-rigid registration result into the depth map corresponding to each image to generate the set of deformation data includes: inputting each vertex in the non-rigid registration result into the depth map corresponding to each image to generate depth data, filtering the depth data to generate effective depth data, and fusing the effective depth data into an array with the same size as the 3D face template model to generate the set of deformation data.

Specifically, each image of the RGB-D image sequence may be processed to obtain the depth map corresponding to each image and the face feature points in each image. In each image, the depth map and the detected face feature points are used to perform the non-rigid registration on the 3D face template model as an existing template. Each vertex in the non-rigid registration result is input into the depth map corresponding to each image. The depth data with a relatively close distance is found as the effective data, which in turn is fused into an array with the same size as the 3D face template model. The fusion result is then used as a data item (that is, the set of deformation data) of a deformed 3D face template model. The 3D face template model is deformed through the set of deformation data.

It may be understood that the depth map includes points having 3D coordinates. 3D coordinates of each vertex in the non-rigid result are compared with 3D coordinates of the points in the depth map, and the depth data with a relatively close distance is used as the effective data.

At block S2, in the last image of the RGB-D image sequence, face details in the non-rigidly registered 3D face template model are reconstructed by a Shape from Shading technology, and a neutral face 3D model is generated based on the deformed 3D face template model and the reconstructed 3D face template model.

Specifically, in the last image of the RGB-D image sequence, the face details in the non-rigidly registered 3D face template model are reconstructed by the Shape from Shading technology, and the target 3D face template model deformed in step S1 and the 3D face template model reconstructed in step S2 are synthesized to generate the 3D neutral face model.

It may be understood that the face in the color and depth input sequence maintains a neutral expression and only performs rigid motions, and the 3D reconstruction of the neutral face is completed by deforming the 3D face template model. In the reconstruction process, (i) the non-rigid registration result of the 3D face template model is used to fuse a more accurate 3D face model, and (ii) the fused 3D face template model is used to obtain a better non-rigid registration result. The two actions (i) and (ii) are iteratively and alternately performed.

In the conventional methods for fusion and reconstruction, the reconstructed 3D face template model does not have a fixed topological structure. In the embodiment of the disclosure, the face obtained by the fusion method herein has the same topological structure as the face template model.

At block S3, the 3D neutral face model and a face hybrid template are processed by a Deformation Transfer technology to generate a face hybrid model. The face hybrid template may include an initial face hybrid model.

After completing the 3D reconstruction of the neutral face, the Deformation Transfer technology is used to complete an initialization of the face hybrid model for customizing facial expressions. In other words, the Deformation Transfer technology may be used to obtain the initialization results of the face hybrid model for customizing facial expressions.

Specifically, with the Deformation Transfer technology, the reconstructed neutral face model with high precision and the initial face hybrid model in the template are used as inputs to obtain the initialization results of the face hybrid model for customizing facial expressions.

At block S4, the face in the RGB-D image sequence is tracked by deforming the 3D neutral face model sequentially through the face hybrid model, a Warping Field technology and the Shape from Shading technology to generate a face tracking result.

Further, in an embodiment of the disclosure, the method further includes: S41, deforming the 3D neutral face model through the customized face hybrid model to generate expression coefficients of the customized face hybrid model; S42, deforming the 3D neutral face model deformed in S41 through the Warping Field technology; and S43, deforming the 3D neutral face model deformed in S42 through the Shape from Shading technology to generate a reconstruction result of a current 3D neutral face model.

The face tracking result includes the reconstruction result of the current 3D neutral face model and the expression coefficients in the face hybrid model.

Specifically, the face in the color and depth input sequence is tracked, and the generated face hybrid model, the Warping Field technology and the Shape from Shading technology are used to achieve high-precision tracking of the face in the input sequence. Finally, the high-precision reconstruction result of the current 3D neutral face model and the expression coefficients of the face hybrid model at this time are obtained.

The tracking method for the face hybrid model used in this embodiment does not limit the space for the changes of face hybrid model, so that the changes of face hybrid model have a high degree of freedom, and the face hybrid model with high precision can be updated.

At block S5, the face hybrid model is updated based on the face tracking result and the facial expressions are customized with the updated face hybrid model.

Specifically, the high-precision reconstruction result of the 3D neutral face model and its corresponding expression coefficients are used to update the face hybrid model.

The motion of each vertex in the updated face hybrid model is solved separately, and the semantics of each expression base in the updated face hybrid model is kept unchanged by using a mask.

According to the method for customizing facial expressions in the embodiments of the disclosure, the non-rigid registration is performed on the 3D face template model with the depth map and face feature points corresponding to each image of the RGB-D image sequence. The 3D face template model is deformed based on the non-rigid registration result and the Shape from Shading technology, to generate the 3D neutral face model. The 3D neutral face model and the face hybrid template are processed with the Deformation Transfer technology, to generate a face hybrid model. The 3D neutral face model is deformed sequentially through the face hybrid model, the Warping Field and the Shape from Shading, to generate the face tracking result. High-precision tracking is performed on the face in the face color and depth sequence, and the high-precision tracking results are directly used to update the face hybrid model. The facial expressions are then customized with the updated face hybrid model. In the embodiments of the disclosure, a face hybrid model is updated based on the high-precision tracking results, thereby automatically generating and customizing in real time realistic facial expressions.

Next, an apparatus for customizing facial expressions according to an embodiment of the disclosure will be described with reference to the accompanying drawings.

FIG. 2 is a structural schematic diagram of an apparatus for customizing facial expressions according to an embodiment of the disclosure.

As illustrated in FIG. 2, the apparatus for customizing facial expressions includes: a processing module 100, a first generation module 200, a second generation module 300, a tracking module 400 and an update module 500.

The processing module 100 is configured to obtain a RGB-D image sequence including a neutral expression of a user, perform non-rigid registration on a three-dimensional (3D) face template model with a depth map and face feature points corresponding to each image of the RGB-D image sequence to obtain a non-rigid registration result, input each vertex in the non-rigid registration result into the depth map corresponding to each image to generate a set of deformation data, and deform the 3D face template model based on the set of deformation data.

The first generation module 200 is configured to reconstruct face details in the non-rigidly registered 3D face template model by a Shape from Shading technology in the last image of the RGB-D image sequence, and generate a 3D neutral face model based on the deformed 3D face template model and the reconstructed 3D face template model.

The second generation module 300 is configured to process the 3D neutral face model and a face hybrid template by a Deformation Transfer technology to generate a face hybrid model.

The tracking module 400 is configured to track the face in the RGB-D image sequence by deforming the 3D neutral face model sequentially through the face hybrid model, a Warping Field technology and the Shape from Shading technology, to generate a face tracking result.

The update module 500 is configured to update the face hybrid model based on the face tracking result and customize the facial expressions with the updated face hybrid model.

The apparatus can generate better reconstruction results of the neutral face, achieve high-precision tracking the face, and generate a high-precision face hybrid model.

Further, in an embodiment of the disclosure, obtaining the RGB-D image sequence including the neutral expression of the user includes:

rotating the user head in up, down, left and right directions in turn while maintaining the neutral expression, and collecting each image of user expressions to form the RGB-D image sequence.

Further, in an embodiment of the disclosure, inputting each vertex in the non-rigid registration result into the depth map corresponding to each image to generate the set of deformation data includes: inputting each vertex in the non-rigid registration result into the depth map corresponding to each image to generate depth data, filtering the depth data to generate effective depth data, and fusing the effective depth data into an array with the same size as the 3D face template model to generate the set of deformation data.

Further, in an embodiment of the disclosure, the tracking module includes: a first transformation unit, a second transformation unit, and a third transformation unit. The first deformation unit is configured to deform the 3D neutral face model through the face hybrid model to generate expression coefficients of the face hybrid model. The second deforming unit is configured to deform the 3D neutral face model deformed in the first deforming unit through the Warping Field technology. The third deformation unit is configured to deform the 3D neutral face model deformed in the second deforming unit through the Shape from Shading technology to generate a reconstruction result.

Further, in an embodiment of the disclosure, the face tracking result includes: the reconstruction result and the expression coefficients of the face hybrid model.

It should be noted that the foregoing explanation of the embodiments of the method for customizing facial expressions is also applicable to the apparatus embodiment, which will not be repeated here.

According to the apparatus for customizing facial expressions in the embodiment of the disclosure, the non-rigid registration is performed on the 3D face template model with the depth map and face feature points corresponding to each image of the RGB-D image sequence. The 3D face template model is deformed based on the non-rigid registration result and the Shape from Shading technology, to generate the 3D neutral face model. The 3D neutral face model and the face hybrid template are processed with the Deformation Transfer technology, to generate a face hybrid model. The 3D neutral face model is deformed sequentially through the face hybrid model, the Warping Field and the Shape from Shading, to generate the face tracking result. High-precision tracking is performed from the face in the face color and depth sequence, and the high-precision tracking results are directly used to update the face hybrid model. The facial expressions are then customized with the updated face hybrid model. In the embodiments of the disclosure, a face hybrid model is updated based on the high-precision tracking results, thereby automatically generating and customizing in real time realistic facial expressions.

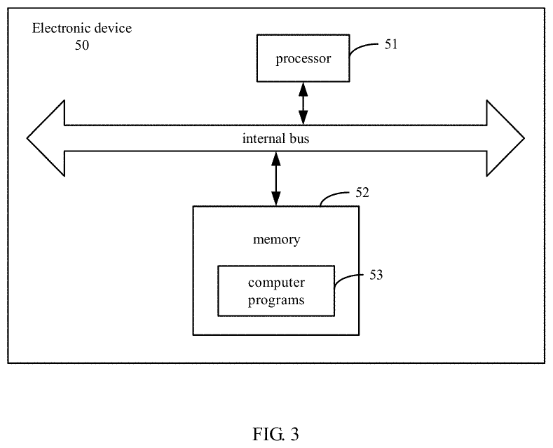

FIG. 3 is a block diagram illustrating an electronic device 50 according to an example embodiment of the disclosure. The electronic device 50 includes a processor 51 and a memory 52. The memory 52 is configured to store executable instructions. The memory 52 includes computer programs 53. The processor 51 is configured to execute blocks of the above-mentioned method.

The processor 51 is configured to execute the computer programs 53 included in the memory 52. The processor 51 may be a central processing unit (CPU) or a general-purpose processor, a digital signal processor (DSP), an application specific integrated circuit (ASIC), a field-programmable gate array (FPGA), another programmable logic device, a discrete gate, a transistor logic device, a discrete hardware component, and the like. The general-purpose processor may be a microprocessor or any conventional processor.

The memory 52 is configured to store computer programs related to the method. The memory 52 may include at least one type of storage medium. The storage medium includes a flash memory, a hard disk, a multimedia card, a card-type memory (such as, a SD (secure digital) or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, etc. The device may cooperate with a network storage device that performs a storage function of the memory by a network connection. The memory 52 may be an internal storage unit of the device 50, such as a hard disk or a memory of the device 50. The memory 52 may also be an external storage device of the device 50, such as a plug-in hard disk, a smart media card (SMC), a secure digital (SD) card, a flash card, disposed on the device 50. Further, the memory 52 may also include both the internal storage unit of the device 50 and the external storage device. The memory 52 is configured to store the computer program 53 and other programs and data required by the device. The memory 52 may also be configured to temporarily store data that has been output or will be output.

The various embodiments described herein may be implemented by using the computer readable medium such as computer software, hardware, or any combination thereof. For a hardware implementation, embodiments described herein may be implemented by using at least one of: an application specific integrated circuit (ASIC), a digital signal processor (DSP), a digital signal processing device (DSPD), a programmable logic device (PLD), a field programmable gate array (FPGA), a processor, a controller, a microcontroller, a microprocessor, and an electronic unit designed to perform the functions described herein. For a software implementation, an implementation such as a procedure or a function may be implemented with a separate software module that allows at least one function or operation to be performed. Software codes may be implemented by a software application (or program) written in any suitable programming language, and the software codes may be stored in the memory and executed by the controller.

The electronic device 50 includes, but is not limited to, a mobile terminal, an ultra-mobile personal computer device, a server, and other electronic device with a computing function. (1) The mobile terminal is characterized by having a function of mobile communication and aiming at providing a voice and data communication. Such mobile terminal includes a smart phone (such as iPhone), a multimedia phone, a functional phone, and a low-end phone. (2) The ultra-mobile personal computer device belongs to a category of personal computer, which has a computing and processing function, and generally has a feature of mobile Internet access. Such terminal includes a PDA (personal digital assistant), a MID (mobile Internet device) and a UMPC (ultra mobile personal computer) devices, such as an iPad. (3) The server provides a computing service. A composition of the server includes a processor, a hard disk, a memory, a system bus, etc. The server is similar to the general computer architecture, but because the server only provides a highly reliable service, it requires a higher processing capacity, stability, reliability, security, scalability and manageability. (4) Other electronic device with the computing function may include, but be not limited to, the processor 51 and the memory 52. It may be understood by the skilled in the art that, FIG. 3 is merely an example of the electronic device 50, and does not constitute a limitation of the electronic device 50. The electronic device 50 may include more or less components than illustrated, some combined components, or different components. For example, the electronic device may also include an input device, an output device, a network access device, a bus, a camera device, etc.

The implementation procedure of the functions of each unit in the above device may refer to the implementation procedure of the corresponding actions in the above method, which is not elaborated here.

In some embodiment, there is also provided a storage medium including instructions, such as the memory 52 including instructions. The above instructions may be executed by the processor 51 of the electronic device 50 to perform the above method. In some embodiments, the storage medium may be a non-transitory computer readable storage medium. For example, the non-transitory computer readable storage medium may include the ROM, the random-access memory (RAM), the CD-ROM (compact disc read-only memory), a magnetic tape, a floppy disk, optical data storage device, etc.

A non-transitory computer readable storage medium is provided. When instructions stored in the storage medium are executed by a processor of a terminal, the terminal is enabled to execute the above method for dispatching a power grid.

In some embodiments, there is also provided a computer program product including executable program codes. The program codes are configured to execute any of the above embodiments of the method when executed by the above device.

In the description of the disclosure, it should be understood that the orientation or positional relationship indicated by the terms such as “center”, “longitudinal”, “transverse”, “length”, “width”, “thickness”, “up”, “down”, “front”, “ Back”, “left”, “right”, “vertical”, “horizontal”, “top”, “bottom”, “inner”, “outer”, “clockwise”, “counterclockwise”, “axial”, “radial”, “circumferential”, etc. is based on the orientation or positional relationship shown in the drawings, and is only for the convenience of describing the disclosure and simplifying the description, but not to indicate or imply said apparatus or element must have a specific orientation or must be constructed and operated in a specific orientation, which therefore cannot be understood as a limitation to the disclosure.

In addition, the terms “first” and “second” are only used for the purposes of description, and cannot be understood as indicating or implying relative importance or implicitly indicating a number of indicated technical features. Therefore, the features defined by “first” and “second” may explicitly or implicitly include at least one of the features. In the description of the disclosure, “a plurality of . . . ” means at least two . . . , such as two, three, etc., unless specifically defined otherwise.

In the disclosure, unless otherwise clearly specified and limited, the terms “installed”, “coupled”, “connected”, “fixed” and other terms should be understood in a broad sense, for example, it can be a fixed or detachable connection or be integrated; it can be mechanically or electrically connected; it can be directly or indirectly connected through an intermediary, it can be internal communication of two components or interaction relationship between the two components, unless specifically defined otherwise. For those skilled in the art, the specific meanings of the above-mentioned terms in the disclosure can be understood according to specific circumstances.

In the disclosure, unless expressly stipulated and defined otherwise, the first feature “on” or “under” the second feature may be the first feature in direct contact with the second feature, or the first feature in indirect contact with the second feature through an intermediary. Moreover, the first feature “over”, “above” and “up” the second feature may mean that the first feature is directly above or obliquely above the second feature, or it simply means that the level of the first feature is higher than that of the second feature. The first feature “under”, “below” and “down” the second feature may mean that the first feature is directly below or obliquely below the second feature, or it simply means that the level of the first feature is smaller than the second feature.

In the description of this specification, descriptions with reference to the terms “one embodiment”, “some embodiments”, “examples”, “specific examples”, or “some examples” etc. mean specific features, structures, materials, or characteristics described in conjunction with the embodiment or example are included in at least one embodiment or example of the disclosure. In this specification, schematic representations of the above terms do not necessarily refer to the same embodiment or example. Moreover, the described specific features, structures, materials or characteristics can be combined in any one or more embodiments or examples in a suitable manner. In addition, those skilled in the art can bind and combine the different embodiments or examples and the features of the different embodiments or examples described in this specification without contradicting each other.

Although the embodiments of the disclosure have been shown and described above, it can be understood that the above-mentioned embodiments are exemplary and should not be construed as limitations to the disclosure. Those skilled in the art can make changes, modifications, substitutions, and modifications to the above embodiments within the scope of the disclosure.

What is claimed is:

1. A method for customizing facial expressions of a user, comprising:
obtaining a RGB-D image sequence including a neutral expression of the user, performing non-rigid registration on a three-dimensional (3D) face template model with a depth map and face feature points corresponding to each image frame of the RGB-D image sequence, inputting each vertex in the non-rigid registration result into the depth map corresponding to each image to generate a set of deformation data, and deforming the 3D face template model based on the set of deformation data;
reconstructing face details in the non-rigidly registered 3D face template model by a Shape from Shading technology in a last image of the RGB-D image sequence, and generating a 3D neutral face model based on the deformed 3D face template model and the reconstructed 3D face template model;
processing the 3D neutral face model and a face hybrid template by a Deformation Transfer technology to generate a face hybrid model;
tracking the face in the RGB-D image sequence by deforming the 3D neutral face model sequentially through the face hybrid model, a Warping Field technology and the Shape from Shading technology, to generate a face tracking result; and
updating the face hybrid model based on the face tracking result and customizing the facial expressions with the updated face hybrid model.

2. The method of claim 1, wherein obtaining the RGB-D image sequence including the neutral expression of the user comprises:
when the user rotates his head in up, down, left and right directions in turn while maintaining the neutral expression, collecting each image of the neutral expression to form the RGB-D image sequence.

3. The method of claim 1, wherein inputting each vertex in the non-rigid registration result into the depth map corresponding to each image to generate the set of deformation data comprises:
inputting each vertex in the non-rigid registration result into the depth map corresponding to each image to generate depth data, filtering the depth data to generate effective depth data, and fusing the effective depth data into an array with the same size as the 3D face template model to generate the set of deformation data.

4. The method of claim 1, wherein deforming the 3D neutral face model comprises:
deforming the 3D neutral face model through the face hybrid model to generate a first 3D neutral face model and expression coefficients of the face hybrid model;
deforming the first 3D neutral face model through the Warping Field technology to generate a second 3D neutral face model; and
deforming the second 3D neutral face model through the Shape from Shading technology to generate a reconstruction result.

5. The method of claim 4, wherein the face tracking result comprises: the reconstruction result and the expression coefficients of the face hybrid model.

6. An apparatus for customizing facial expressions of a user, comprising:
a processor; and
a memory, having instructions stored thereon and executable by the processor;
wherein when the instructions are executed by the processor, the processor is configured to:
obtain a RGB-D image sequence including a neutral expression of the user, perform non-rigid registration on a three-dimensional (3D) face template model with a depth map and face feature points corresponding to each image of the RGB-D image sequence, input each vertex in the non-rigid registration result into the depth map corresponding to each image to generate a set of deformation data, and deform the 3D face template model based on the set of deformation data;
reconstruct face details in the non-rigidly registered 3D face template model by a Shape from Shading technology in a last image of the RGB-D image sequence, and generate a 3D neutral face model based on the deformed 3D face template model and the reconstructed 3D face template model;
process the 3D neutral face model and a face hybrid template by a Deformation Transfer technology to generate a face hybrid model;
track the face in the RGB-D image sequence by deforming the 3D neutral face model sequentially through the customized face hybrid model, a Warping Field technology and the Shape from Shading technology, to generate a face tracking result; and
update the face hybrid model based on the face tracking result and customize the facial expressions with the updated face hybrid model.

7. The apparatus of claim 6, wherein the processor is further configured to:
when the user rotates his head in up, down, left and right directions in turn while maintaining the neutral expression, collecting each image of the neutral expression to form the RGB-D image sequence.

8. The apparatus of claim 6, wherein the processor is further configured to:
inputt each vertex in the non-rigid registration result into the depth map corresponding to each image to generate depth data, filter the depth data to generate effective depth data, and fuse the effective depth data into an array with the same size as the 3D face template model to generate the set of deformation data.

9. The apparatus of claim 6, wherein the processor is further configured to:
deform the 3D neutral face model through the face hybrid model to generate a first 3D neutral face model and expression coefficients of the face hybrid model;
deform the first 3D neutral face model through the Warping Field technology to generate a second 3D neutral face model; and
deform the second 3D neutral face model through the Shape from Shading technology to generate a reconstruction result.

10. The apparatus of claim 9, wherein the face tracking result comprises: the reconstruction result and the expression coefficients of the face hybrid model.

11. A non-transitory computer readable storage medium, having instructions stored thereon, wherein when the instructions are executed by a processor, a method for customizing facial expressions of a user is performed, the method comprising:
obtaining a RGB-D image sequence including a neutral expression of the user, performing non-rigid registration on a three-dimensional (3D) face template model with a depth map and face feature points corresponding to each image frame of the RGB-D image sequence, inputting each vertex in the non-rigid registration result into the depth map corresponding to each image to generate a set of deformation data, and deforming the 3D face template model based on the set of deformation data;
reconstructing face details in the non-rigidly registered 3D face template model by a Shape from Shading technology in a last image of the RGB-D image sequence, and generating a 3D neutral face model based on the deformed 3D face template model and the reconstructed 3D face template model;
processing the 3D neutral face model and a face hybrid template by a Deformation Transfer technology to generate a face hybrid model;
tracking the face in the RGB-D image sequence by deforming the 3D neutral face model sequentially through the face hybrid model, a Warping Field technology and the Shape from Shading technology, to generate a face tracking result; and
updating the face hybrid model based on the face tracking result and customizing the facial expressions with the updated face hybrid model.

12. The storage medium of claim 11, wherein obtaining the RGB-D image sequence including the neutral expression of the user comprises:
when the user rotates his head in up, down, left and right directions in turn while maintaining the neutral expression, collecting each image of the neutral expression to form the RGB-D image sequence.

13. The storage medium of claim 11, wherein inputting each vertex in the non-rigid registration result into the depth map corresponding to each image to generate the set of deformation data comprises:
inputting each vertex in the non-rigid registration result into the depth map corresponding to each image to generate depth data, filtering the depth data to generate effective depth data, and fusing the effective depth data into an array with the same size as the 3D face template model to generate the set of deformation data.

14. The storage medium of claim 11, wherein deforming the 3D neutral face model comprises:
deforming the 3D neutral face model through the face hybrid model to generate a first 3D neutral face model and expression coefficients of the face hybrid model;
deforming the first 3D neutral face model through the Warping Field technology to generate a second 3D neutral face model; and
deforming the second 3D neutral face model through the Shape from Shading technology to generate a reconstruction result.

15. The storage medium of claim 14, wherein the face tracking result comprises: the reconstruction result and the expression coefficients of the customized face hybrid model.
